(19) United States
(12) Patent Application Publication
(10) Pub. No.: US 2003/0081187 A1
(43) Pub. Date: May 1, 2003

(54) Exposure device

(75) Inventor: Satoshi Kaiho, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 09/984,765

(22) Filed: Oct. 31, 2001

(51) Int. Cl. G03B 27/80

(52) U.S. Cl. 355/38; 355/40; 355/41

(57) ABSTRACT

An exposure device comprises a plurality of optical members including a light emitting unit which emits laser light based on an image signal and a polygon mirror which deflects the laser light in a main scanning direction. The optical members are positioned with respect to one another with high accuracy and attached to a case. A cover deformable by external force is attached to an opening portion of the case. An opening to allow passage of laser beam is formed in a predetermined portion of the cover. A dustproof glass is attached to the opening via an attachment member made of a rigid body.

### BACKGROUND OF THE INVENTION

The present invention relates to an optical device containing a plurality of optical members positioned with respect to one another with high accuracy inside a case, and more particularly to an exposure device incorporated in a copying machine or a printer.

Conventionally, an exposure device incorporated in a copying machine or a printer is known as an optical device including a plurality of optical members. The exposure device has a case forming its housing. In the case, a laser light source which emits laser light based on image data, a polygon mirror which exposes and scans the surface of a photosensitive drum with laser light deflected in a main scanning direction, and a plurality of optical members are mounted, positioned with one another with high accuracy. The optical members guide the laser beam emitted from the laser light source to the polygon mirror and the laser light reflected by the polygon mirror to the photosensitive drum. A cover, which covers the laser light source, the polygon mirror and the optical members, is attached to an opening portion of the case with screws or the like.

However, if the cover is warped or distorted, the case may receive load due to the rigidity of the cover, when the cover is screwed to the opening portion of the case, so that the case may be deformed. If the case is deformed, the positional accuracy of the members positioned with great precision may be reduced, with the result that the performance of the exposure device may be lowered. This is a problem of the conventional device.

### BRIEF SUMMARY OF THE INVENTION

The present invention has been made in consideration of the above matter, and its object is to provide an exposure device that can increase the positional accuracy of the optical members.

To achieve the above object, an optical device of this invention comprises at least one light emitting section which emits a light beam; at least one optical member which transmits the light beam emitted from the light emitting section; a first member to which the light emitting section and the optical member are attached in a state that they are positioned with respect to each other with high accuracy; and a second member deformable by external force, which is attached to the first member to enclose, together with the first member, the light emitting section and the optical member.

An exposure device of this invention comprises: at least one light emitting section which emits laser light based on an image signal; a deflecting scanning section which deflects the laser light emitted from the light emitting section in a main scanning direction, exposes and scans an image carrier, and forms a latent image on the image carrier; a plurality of optical members which guide the laser beam emitted from the light emitting section to the deflecting scanning section, and guide the laser beam deflected by the deflecting scanning section to the image carrier; a first member in which the light emitting section, the deflecting scanning section and the optical members are attached in a state that they are positioned with respect to one another with high accuracy; and a second member deformable by external force, which is attached to the first member to enclose, together with the first member, the light emitting section, the deflection scanning section and the optical members.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a plan view showing an exposure device according to an embodiment of the present invention;

FIG. 2 is a front view of the exposure device shown in FIG. 1;

FIG. 3 is a plan view showing a light emitting unit incorporated in the exposure device shown in FIG. 1;

FIG. 4 is a rear view of the light emitting unit shown in FIG. 3 as viewed from the rear end side;

FIG. 5 is an exploded view showing a state of assembling the case and the cover of the exposure device;

FIG. 6 is a front view showing a state in which the cover is attached to the case shown in FIG. 5;

FIG. 7 is a partially enlarged perspective view showing a structure of a main portion of the cover;

FIG. 8 is a cross sectional view showing a main portion of FIG. 7;

FIG. 9 is a cross sectional view showing a modification of the cover;

FIG. 10 is an exploded view showing a state of assembling the case and the cover of an exposure device according to another embodiment of the present invention; and

FIG. 11 is a front view showing a state in which the cover is attached to the case shown in FIG. 10.

### DETAILED DESCRIPTION OF THE INVENTION

Embodiments of the present invention will be described in detail with reference to the drawings.

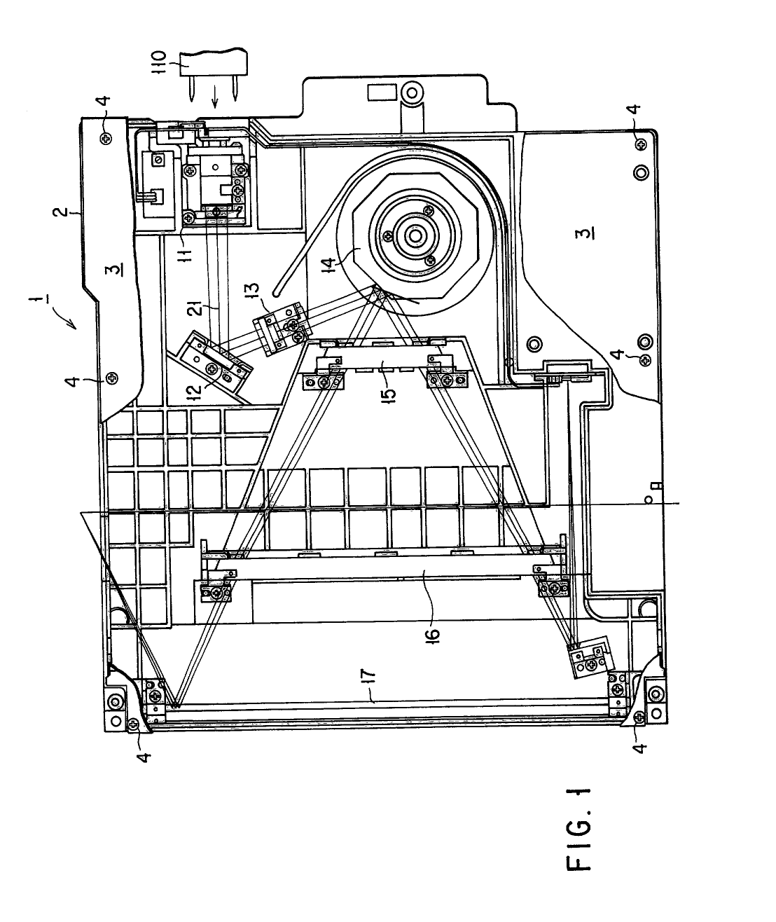

FIG. 1 is a plan view of an exposure device 1 according to an embodiment of the present invention. FIG. 2 is a front view showing the exposure device 1 along with a photosensitive drum 10 (image carrier). The exposure device 1 is incorporated into an image forming apparatus, for example, a digital copying machine or a color printer. More specifically, structural elements (not shown), other than the exposure device 1, i.e., known structural elements, such as a static electricity charger, a developing device, a transfer charger and a peeling charger, are arranged around the photosensitive drum 10.

The exposure device 1 has a case 2 (first member) in which a plurality of optical elements described later are positioned with respect to one another with high accuracy. The case 2 is shaped as a substantially rectangular box. To keep the positional accuracy of the optical elements contained therein with great precision, the case 2 is formed of a material having relatively high rigidness, such as polycarbonate.

The upper side of the case 2 is opened as an opening 2a. A cover 3 (second member) for closing the opening 2a is attached thereto by a plurality of screws 4. As will be described later, the cover 3 has a structure deformable by external force, or it is made of a material deformable by external force.

In the case 2, a light emitting unit 11, a galvano mirror 12, a cylindrical lens 13, a polygon mirror 14, two fθ lenses 15 and 16, and a return mirror 17 are arranged along the light path of laser light. These optical members are positioned with high accuracy relative to one another and fixed in the case 2. The light emitting unit 11 also functions as a light emitting portion of the present invention, and the polygon mirror 14 also functions as a deflection scanning portion of the present invention. A connector 110 for inputting a driving signal is connected to the light emitting unit 11.

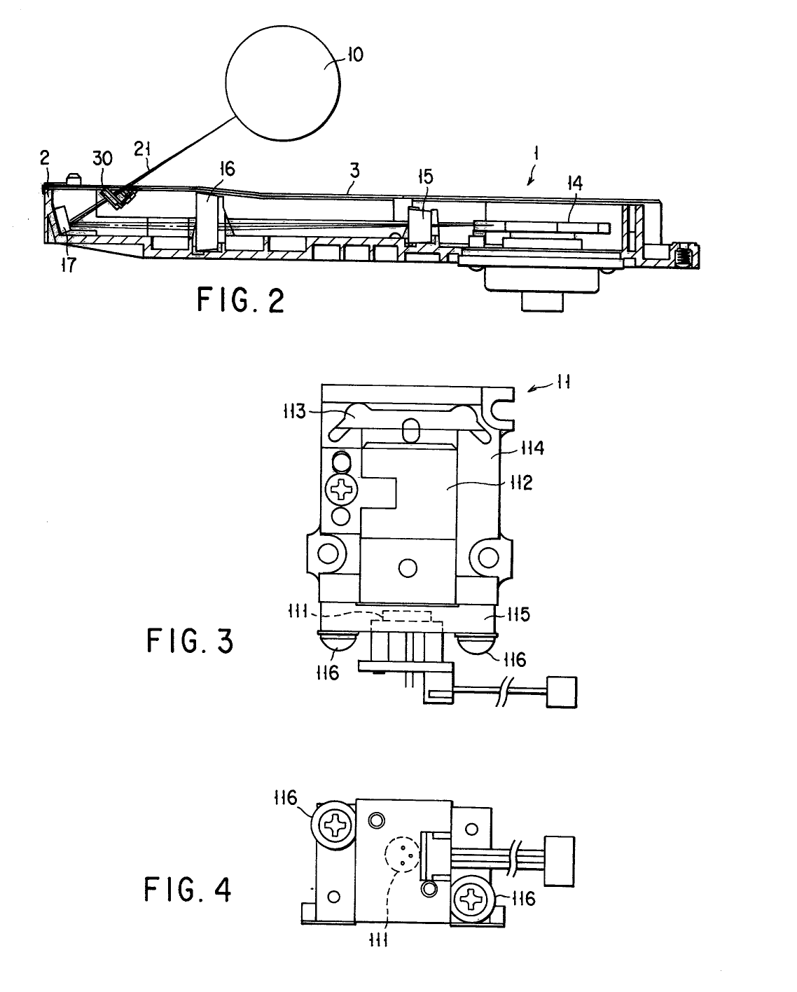

As shown in FIGS. 3 and 4, the light emitting unit 11 has a semiconductor laser element 111, a shaping lens 112, and a diaphragm 113. The semiconductor laser element 111 emits laser light 21 (see FIG. 1) based on an image signal. The shaping lens 112 has a limited focus lens and a collimator lens to shape a cross sectional form of the laser light. The diaphragm 113 has an opening which allows passage of the laser light 21 to shape the cross sectional form thereof. The shaping lens 112 is held by a lens holder 114 made of a metal such as aluminum die-cast or plastic such as polycarbonate. The semiconductor laser element 111 is held by an LD holder 115 and fixed to the lens holder 114 by screws 116.

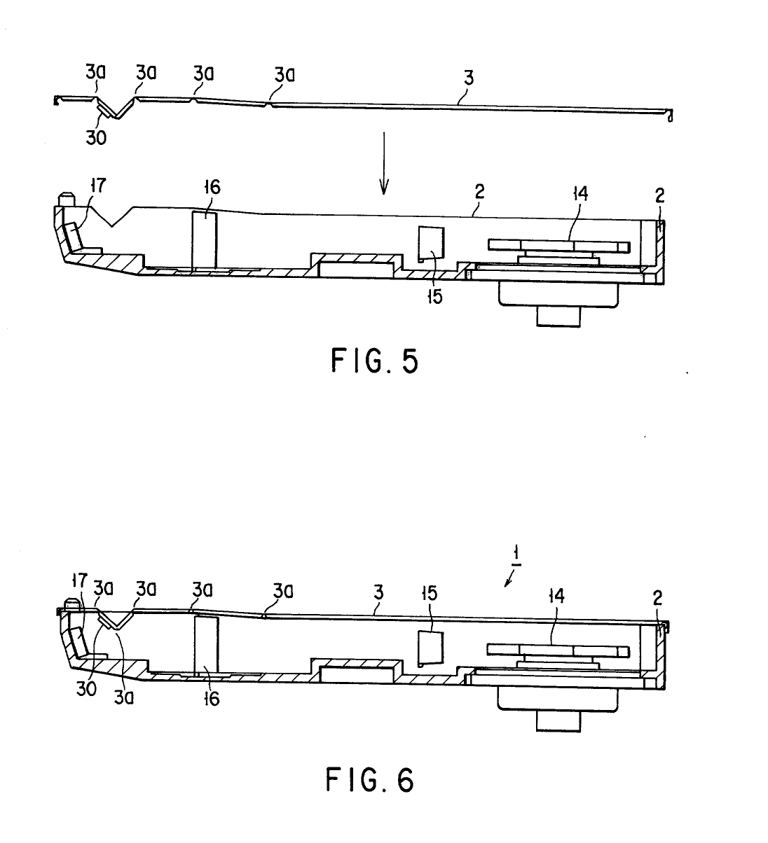

As shown in FIGS. 5 and 6, the cover 3 of this embodiment has a plurality of bend portions 3a. Each bend portion 3a can be easily bent and deformed by external force. The cover 3 is set to the opening 2a and fixed to the case 2 by the screws 4. Thus, since the cover 3 can be deformed, the case 2 is prevented from deforming due to rigidity of the cover 3 in the state where the cover is attached to the case 2.

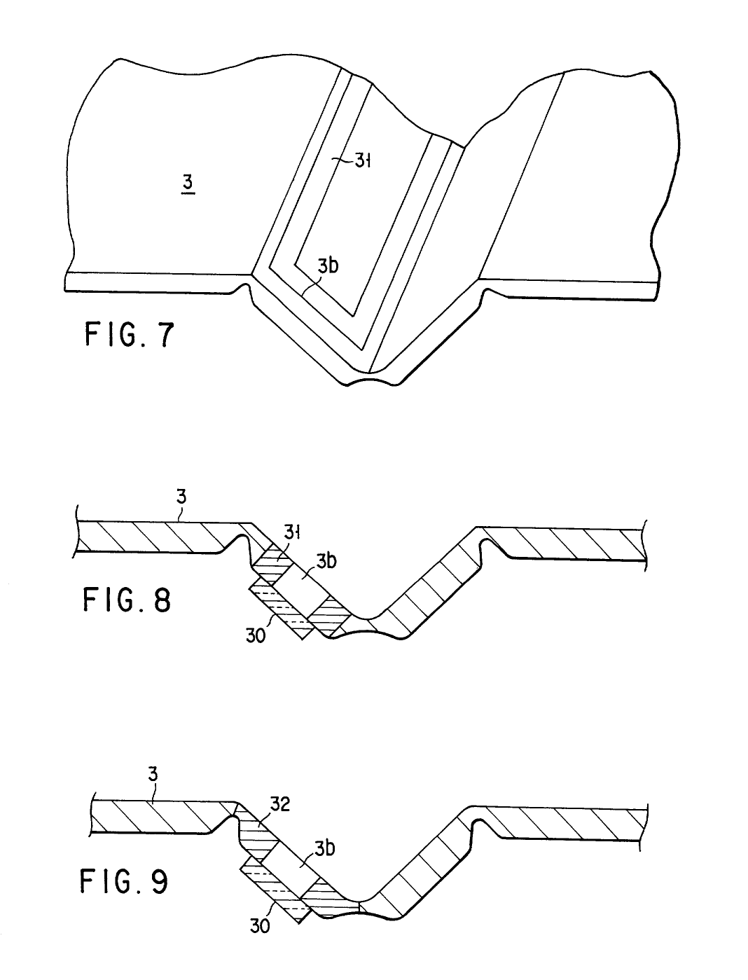

As shown in detail in FIGS. 7 and 8, a thin slit-like rectangular opening 3b is formed in a predetermined position of the cover 3 to allow passage of the laser light 21 guided via the optical members to the photosensitive drum 10. A rectangular frame-shaped attachment member 31, made of a rigid body, is fixed to the opening 3b. A rectangular plate-shaped dustproof glass 30 (transparent member) is attached to the rear side of the attachment member 31. Thus, since the attachment member 31 for use in attachment of the dustproof glass 30 to the opening 3b of the cover 3 is made of a rigid body, even when the cover 3 is deformed, the dustproof glass 30 is protected from load, so that undesirable deformation of the dustproof glass 30 can be prevented.

FIG. 9 shows a modification of the attachment structure of the dustproof glass 30. According to this modification, the cover 3 itself includes, only around the opening 3b, a rigid body portion 32, which is made of a material functioning like the attachment member 31 as described above. The dustproof glass 30 is attached to the rear side of the cover 3 to cover the opening 3b. With this structure also, deformation of the dustproof glass 30 can be prevented, when the cover 3 is deformed.

Then, the laser light 21 emitted from the light emitting unit 11 is reflected by the galvano mirror 12, thereafter, passed through the cylindrical lens 13 and incident on the polygon mirror 14. The laser beam 21 reflected by the polygon mirror 14 is deflected in the main scanning direction by the rotation of the polygon mirror 14. It is passed through the two fθ lenses 15 and 16, reflected by the return mirror 17, and radiated on the surface of the photosensitive drum 10. At this time, the laser beam 21 reflected by the return mirror 17 passes the dustproof glass 30 fixed to the cover 3.

As described above, according to this embodiment, the cover 3, which closes the opening 2a of the case 2 in which a plurality of optical members positioned with high accuracy are attached, can be deformed by an external force. Therefore, in the state where the cover 3 is attached to the case 2, the case 2 is prevented from deforming due to rigidity of the cover 3. As a result, the positional accuracy of the optical members attached to the case 2 can be maintained with great precision. Accordingly, reduction in performance of the exposure device 1, due to the positional deviation of the optical members, can be prevented. Note that the cover 3 can be deformed to such an extent that at least the case 2 may not be deformed, in the state where the cover 3 is attached to the case 2.

Further, according to this embodiment, since the opening 3b to allow passage of the laser light is formed on the cover 3 side, it is unnecessary to form an opening on the case 2 side. Therefore, the rigidity of the case 2 is not reduced.

Furthermore, according to this embodiment, the dustproof glass 30 is attached via the attachment member 31 made of a rigid body to the opening 3b of the cover 3 that is deformable by external force. Therefore, the dustproof glass 30 is prevented from deforming when the cover 3 is deformed. As a result, the laser light passed through the dustproof glass 30 is not adversely influenced by deformation of the dustproof glass 30. Consequently, reduction in performance of the exposure device 1 can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

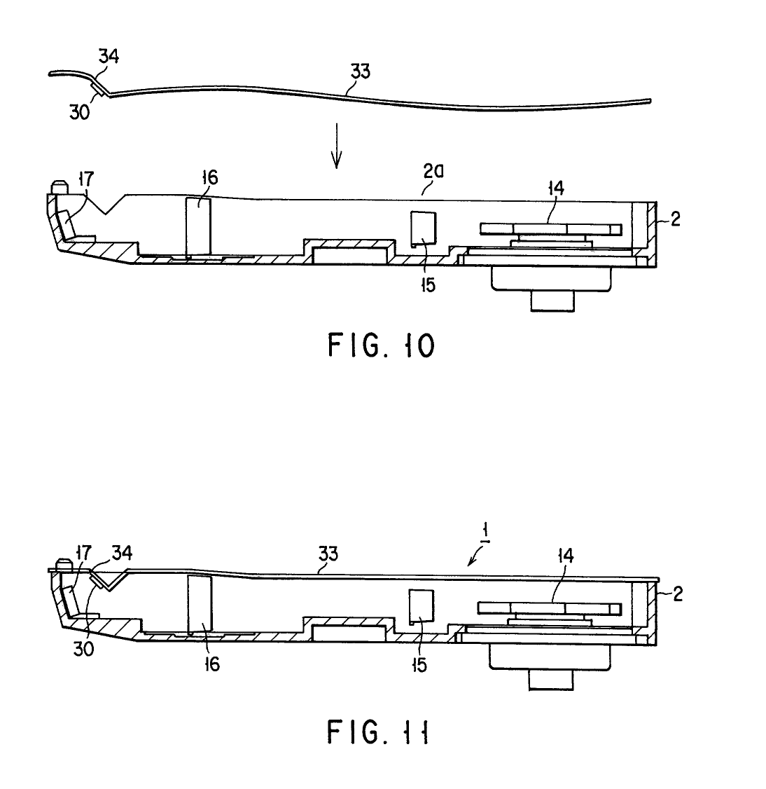

For example, in the embodiment described above, the cover 3 has the bending portions 3a, so that it can be deformable. However, the present invention is not limited to this embodiment. As shown in FIGS. 10 and 11, the cover 3 in its entirety may be formed of an elastic member 33, with a rigid body portion 34 being formed only around the opening 3b and the dustproof 30 being attached to the rigid body portion 34.

Further, in the embodiments described above, the optical members are attached to the case 2. However, the present invention is not limited to the embodiments. The cover 3 may be undeformable, and a plurality of optical members may be attached to the cover 3. In this case, it is only necessary that the structure or material of the case 2 be deformable by external force.

Furthermore, in the embodiment described above, the exposure device 1 is located under the photosensitive drum 10. However, the exposure device 1, in the upside-down state, may be located above the photosensitive drum 10. In this case, the cover 3 is located under the case 2.

What is claimed is:

1. An optical device comprising:
at least one light emitting section which emits a light beam;
at least one optical member which transmits the light beam emitted from the light emitting section;
a first member to which the light emitting section and the optical member are attached in a state that they are positioned with respect to each other with high accuracy; and
a second member deformable by external force, which is attached to the first member to enclose, together with the first member, the light emitting section and the optical member.

2. An optical device according to claim 1, wherein the second member is deformable at least to an extent that the first member is not deformed, when it is attached to the first member.

3. An optical device according to claim 2, wherein the second member has an opening to allow passage of the light beam transmitted through the optical member.

4. An optical device according to claim 3, wherein an attachment member to attach a light-transmissible transparent member to the opening is attached to the opening, the attachment member functioning to prevent the transparent member from deforming when the second member is deformed.

5. An optical device according to claim 1, wherein the first member is a case which contains the light emitting section and the optical member, and the second member is a cover which closes the case.

6. An exposure device comprising:
at least one light emitting section which emits laser light based on an image signal;
a deflecting scanning section which deflects the laser light emitted from the light emitting section in a main scanning direction, exposes and scans an image carrier, and forms a latent image on the image carrier;
a plurality of optical members which guide the laser beam emitted from the light emitting section to the deflecting scanning section, and guide the laser beam deflected by the deflecting scanning section to the image carrier;
a first member in which the light emitting section, the deflecting scanning section and the optical members are attached in a state that they are positioned with respect to one another with high accuracy; and
a second member deformable by external force, which is attached to the first member to enclose, together with the first member, the light emitting section, the deflection scanning section and the optical members.

7. An exposure device according to claim 6, wherein the second member is deformable at least to an extent that the first member is not deformed, when it is attached to the first member.

8. An exposure device according to claim 7, wherein the second member has an opening to emit the laser light guided through the optical members toward the image carrier.

9. An exposure device according to claim 8, wherein an attachment member to attach a laser light-transmissible transparent member to the opening is attached to the opening, the attachment member functioning to prevent the transparent member from deforming when the second member is deformed.

10. An exposure device according to claim 6, wherein the first member is a case which contains the light emitting section, the deflecting scanning section and the optical members, and the second member is a cover which closes the case.
